(19) United States
(12) Patent Application Publication
(10) Pub. No.: US 2024/0362909 A1
(43) Pub. Date: Oct. 31, 2024

(54) METHOD AND SYSTEM FOR DELINEATING AGRICULTURAL FIELDS IN SATELLITE IMAGES

(71) Applicant: DIGIFARM AS, Hamar (NO)

(72) Inventors: Alexei MELNITCHOUCK, Calgary (CA); Nils Solum HELSET, Ridabu (NO); Yosef AKHTMAN, St-Prex (CH); Konstantin VARIK, Javea Alicante (ES)

(21) Appl. No.: 18/692,725

(22) PCT Filed: Sep. 14, 2022
(86) PCT No.: PCT/NO2022/050210

§ 371 Date: Mar. 15, 2024

(30) Foreign Application Priority Data
Sep. 16, 2021 (NO) 20211116

(51) Int. Cl. G06V 20/13; G06V 10/26; G06V 10/32; G06V 10/776; G06V 10/82; G06V 20/10

(52) U.S. Cl. CPC G06V 20/13; G06V 10/26; G06V 10/32; G06V 10/776; G06V 10/82; G06V 20/188

(57) ABSTRACT

A computer-based system (210) for delineating agricultural fields based on satellite images includes a first subsystem (201) configured to receive at least one multitemporal, multispectral satellite image sequence (101) and pre-processing the images in the at least one multitemporal, multispectral satellite image sequence to generate a pre-processed image sequence (303) of multitemporal multispectral images covering a specific geographical region; a second subsystem (202) configured to perform a super-resolution method on the images in the pre-processed image sequence to generate a high-resolution image sequence (403) of multitemporal multispectral images where corresponding pixel positions in images in the sequence relate to the same geographical ground position; and a third subsystem (203) including a delineating artificial neural network (501) trained to classify pixel positions in the high-resolution image sequence (403) as being associated with a geographical ground position that is part of an agricultural field (104) or not part of an agricultural field.

### TECHNICAL FIELD

The present invention relates to a method and devices for detecting geographical location, structure, shape, and area of agricultural fields using satellite imaging data. More specifically the invention relates to a method and a system for analyzing sequences of satellite images of the earth's surface in order to precisely delineate field boundaries.

### BACKGROUND

Agriculture and food production are vital parts of the global economy. By some estimates, the world population is expected to grow from 7.2 billion today to 10 billion by 2050, which may require a 70% growth in global food supplies from current levels (2019). In parallel with this rise in population crop production is predicted to drop by 2% according to the UN. The EU-region alone, which represents 11.9% of total global crop-production, could face crop yield reduction of up to 3.7% due to +2° C. global warming. This presents a widely recognized need for farmers to increase food production by enhancing efficiency, and to protect farmlands and the environment. Currently, 40% of the world's agricultural fields are over-fertilized, and at the same time as farmers are losing 15-20% in yield potential through inadequate input application. Added to this, input costs including fertilizer, seeds and crop protection represent over 50% of the total costs. The potential contribution of technological innovation in agriculture is to increase the efficiency and sustainability of large industrial farming and the productivity and scalability of small-holder farming (farms smaller than 2 hectares, or 5 acres), which represents 83% of the global agricultural fields.

A wide range of technological solutions, widely known as precision farming, have recently been proposed. These solutions aim to offer significant improvements to the efficiency and productivity of agricultural production by in-field optimization of the numerous agrochemical operations involved in the cultivation of agricultural produce. In particular these methods rely on the digital imaging data obtained from Earth Observation satellites to analyze the condition of the growing plants and assist the farmer to make optimum operational decisions throughout the growing season. Most of such methods rely on precise knowledge of georeferenced boundaries of individual fields in order to enable accurate analysis of the satellite imagery and other georeferenced precision farming data, such as soil information, yield monitor data, etc.

In addition to analysis, farm management and operations also require precise information about the farmed area, based on georeferenced field boundaries. This information is crucial for precise calculation of the amount of crop inputs, such as fertilizers, seeds, and crop protection products, to be applied in each field, as well as for taxation, crop insurance, farming subsidies, farm logistics, land management, field activities, and many other purposes and farm operations.

In many cases, however, the precise and up-to-date field boundaries needed for deployment of precision farming solutions are not readily available. The challenge is that existing large scale field boundary data is outdated and inaccurate, which affects the entire agricultural value chain from pre-production to grain-processing. Large scale boundary data is managed through national agencies (Cadastral): In Norway data from the Norwegian Institute of Bioeconomy Research (NIBIO) dates back to 1990, the 27 EU-regions have the Land Parcel Identification System (LPIS) through the Common Agriculture Policy (CAP), and the United States Department of Agriculture (Farm Service Agency) maintains the Common Land Units (CLUs) database with over 32 million parcels. The CLUs were created by hand-digitizing field boundaries in a Geographical Information System (GIS) in 2008 and have not been updated since due to significant cost and resources required to redraw boundaries one by one.

The approach of manually drawing boundaries is still used by the private sector (B2B/Farm Management Systems) and national and regional agencies (27-regions in the EU). Limitations of manual hand-digitization include (a) non-scalability and inaccuracy due to resource and time intensiveness for non-GIS-skilled users to manually draw millions of field boundaries every year, with predictable impact on the resulting accuracy, and (b) manual digitization of boundaries makes it very challenging to detect and identify in-field objects such as irrigation issues (wet-spots), non-seeded acres, shadows from trees, agricultural objects such as haystacks, and electrical lines. This combined with the fact that boundaries established based on available cadastral data are only drawn and defined once in a growth season or even less frequently, giving no ability to detect changes in field boundaries (seeded acres) from seeding to harvesting through the growth season.

As boundaries and seeded acreage change every season, the existing data becomes increasingly unreliable and inaccurate over time. The present applicant has estimated that over 20% of all field boundaries in Norway are inaccurate, affecting the distribution of €1 billion in annual subsidies based on farmed acreage. Only about 10% of all applications are checked and confirmed by authorities. In the 27 countries in the EU region only about 5% of all applications are checked, which means that over €45.5 billion in subsidies annually are distributed based on inaccurate acreage estimates.

A number of field boundary delineation systems have been developed and are commercially available. However, these systems largely do not satisfy the requirements of precision farming technology for several reasons. Field delineation using ground-based navigation systems and devices is very expensive. Field delineation systems that use free or low-cost Earth Observation data do not have sufficient spatial resolution (Landsat 30 m, Modis at 250 m and Sentinel-2 at 10 m) and are therefore not able to provide the geographic accuracy necessary for precision farming applications, especially considering that 70% of all agricultural fields in the EU are smaller than 5 hectares while 83% of the world's fields are smaller than 2 hectares. Consequently, the Satellite-data resolution available is insufficient for properly detecting field boundaries and seeded acreage. Field delineation systems that use archive-based Earth Observation data produce field boundaries that are often out-of-date and thus are not sufficiently reliable. Finally, field delineation systems that use up-to-date commercial Earth Observation data such as Maxar, Planet (avg. $1.50 per single image covering one km²) among others are too expensive for large-scale commercial use in agriculture.

Against this background, there is clearly a need for novel methods and systems that generate high-precision, low-cost, affordable, and up-do-date field boundaries that overcome, or at least mitigate, the aforementioned limitations.

### SUMMARY OF THE DISCLOSURE

In order to address the shortcomings and deficiencies of currently available data and methods relating to delineation of agricultural fields, a method has been developed for utilizing a computer system to delineate agricultural fields using satellite images. The method comprises obtaining at least one multitemporal, multispectral satellite image sequence, pre-processing the images in the at least one multitemporal, multispectral satellite image sequence to generate a pre-processed image sequence of multitemporal multispectral images covering a specific geographical region, using a super-resolution method on the images in the pre-processed image sequence to generate a high-resolution image sequence of multitemporal multispectral images where corresponding pixel positions in images in the sequence relate to the same geographical ground position, and using a delineating artificial neural network to classify pixel positions in the high-resolution image sequence as being associated with a geographical ground position that is part of an agricultural field or not being part of an agricultural field.

In some embodiments the super-resolution method is performed by a resolution enhancing convolutional neural network.

The pre-processing may include, for pixels in the images in the at least one obtained satellite image sequence, performing at least one of: converting received pixel values to bottom of atmosphere (BOA) reflectance, performing data assimilation, and performing geo-referencing.

In some embodiments the at least one multitemporal, multispectral satellite image sequence is a plurality of such image sequences, and the method comprises using a fusion artificial neural network to receive the plurality of multitemporal, multispectral imaging sequences as input and produce a single consolidated multi-temporal multi-spectral imaging data sequence as output.

The delineating artificial neural network may in some embodiments be trained to generate two output masks. A first output mask may classify pixel positions as field or background, while a second output mask may classify pixel positions as field boundary or not field boundary. A combined output mask may then be generated. In this combined output mask pixel positions classified as field in the first output mask may be re-classified as background if they are classified as field boundary in the second output mask. This can be done by subtracting the field boundary mask from the field mask, provided that appropriate values are assigned to the variously classified pixel positions.

The delineating artificial neural network may, in some embodiments, generate probability scores for the pixel positions in the high-resolution image sequence and classification of pixel positions may then be performed based on whether respective probability scores are above or below a predetermined threshold value.

In some embodiments of methods of the invention multiple models from the training of the delineating artificial neural network may be retained. These will represent slightly different assignment of probability scores for the various pixel positions. The classification of pixel positions in the high-resolution image sequence may then include using the multiple models to produce multiple probability scores for the pixel positions and calculate an average probability score for each such pixel position to represent the final output from this neural network. Standard deviation may also be calculated from the multiple probability scores, and these scores may be used as an indication of the confidence level of the output.

In some embodiments of the invention quality assessment of the classification of pixel positions by the delineating artificial neural network is performed, and if the quality assessment produces a result that fails to satisfy a predetermined quality requirement, the delineating artificial neural network may be retrained. This may be done by manually annotating agricultural fields in images of one or more high-resolution image sequences that cover areas for which quality assessment has failed, and retraining the delineating artificial neural network with the manually annotated high-resolution image sequences.

The output from the delineating artificial neural network may be used differently in different applications depending on purpose and need. Typically, the output may be post-processed and then combined with an image representing a corresponding geographical area. Such an image may be stored or transmitted as an image where agricultural fields are delineated.

In another aspect of the invention a computer-based system for delineating agricultural fields based on satellite images is provided. Such a system includes a first subsystem configured to receive at least one multitemporal, multispectral satellite image sequence and pre-process the images to generate a pre-processed image sequence covering a specific geographical region. A second subsystem is configured to perform a super-resolution method on the images in the pre-processed image sequence to generate a high-resolution image sequence of multitemporal multispectral images where corresponding pixel positions in images in the sequence relate to the same geographical ground position. A third subsystem includes a delineating artificial neural network trained to classify pixel positions in the high-resolution image sequence as being associated with a geographical ground position that is part of an agricultural field or not being part of an agricultural field. The subsystems may be implemented on the same or on different computers, and even the subsystems themselves may be distributed over several computers. In embodiments where the computer system is implemented on several computers, these do not have to be located at the same place as long as they are able to communicate with one another.

A computer-based system according to the invention may include various modules and components capable of receiving satellite images, processing them in accordance with the principles of the invention, and deliver generated output in the form of files or other data indicating field delineations, for example as boundaries overlaid on images. In some embodiments the second subsystem includes a resolution enhancing convolutional neural network trained to receive multitemporal, multispectral image sequences as input and generate high-resolution image sequences as output.

The first subsystem may include at least one of a module configured to convert received pixel values to bottom of atmosphere (BOA) reflectance values, a data assimilation module, and a geo-referencing module.

The first subsystem may be configured to receive a plurality of multitemporal, multispectral satellite image sequences and include a fusion artificial neural network to receive the plurality of multitemporal, multispectral imaging sequences as input and produce a single consolidated multi-temporal multi-spectral imaging data sequence as output.

The delineating artificial neural network may have been trained to generate two output masks, a first output mask that classifies pixel positions as field or background, a second output mask that classifies pixel positions as field boundary or not field boundary, and a combined output mask where pixel positions classified as field in the first output mask are re-classified as background if they are classified as field boundary in the second output mask.

The delineating artificial neural network may also have been trained to generate probability scores for the pixel positions in high-resolution image sequences and to classify pixel positions based on whether respective probability scores are above or below a predetermined threshold value. Multiple models from the training of the delineating artificial neural network may have been retained such that the classification of pixel positions in the high-resolution image sequence may be based on use of the multiple models, as described above.

The delineating artificial neural network may also be configured to generate confidence scores that are indicative of the quality of the field delineation results, or deliver additional data to a quality assessment module that is configured to generate such scores. Possible calculations and output for this purpose may include calculating a standard deviation from the multiple probability scores.

A quality assessment module may be configured to perform a quality assessment of the classification of pixel positions by the delineating artificial neural network, and, if the quality assessment produces a result that fails to satisfy a predetermined quality requirement, issue an alert indicative of a need to retrain the delineating artificial neural network. The retraining may be performed as described above and may involve a workstation for manual annotation of images and a retraining module that is part of the third subsystem and configured to perform retraining of the delineating artificial neural network using manually annotated high-resolution image sequences provided by the workstation.

The third subsystem may also include a post-processing module configured to combine the classification of pixel positions from the delineating artificial neural network with an image representing a corresponding geographical area; and storing or transmitting the result as an image where agricultural fields are delineated.

The invention also provides a non-transitory computer-readable medium storing instructions enabling one or more processors to perform the methods of the invention.

### BRIEF DESCRIPTION OF THE DRAWINGS

The attached drawings show non-limiting examples of embodiments of the invention. The examples may include elements that do not necessarily have to be present in all embodiments, but in the interest of avoiding unnecessary repetition drawings showing embodiments with a subset of the described features have not been included. It will be understood that while some features or elements are optional, other elements may be reconfigured such that certain functions are performed in a different sequence than the drawings depict. Certain standard elements such as computer screens and user input devices have been left out in the interest of focusing on the specifics that best explain the invention.

FIG. 1 is a representation of the generation of field delineation based on satellite images of agricultural fields;

FIG. 2 presents an overview of a system and a process according to the invention;

FIG. 3 shows a representation of a sub-system for pre-processing satellite images prior to field delineation;

FIG. 4 shows a representation of a sub-system for generating a super-resolution output based on lower resolution satellite images;

FIG. 5 shows a representation of a sub-system for field delineation, quality assessment, retraining and output;

FIG. 6 is a more detailed view of output masks generated by a field delineation module; and

FIG. 7 is a flow chart representation of a process according to the invention.

### DETAILED DESCRIPTION

The present invention will be better understood with reference to the following detailed description of exemplary embodiments with reference to the attached drawings. However, those skilled in the art will readily appreciate that the detailed descriptions given herein are intended for explanatory purposes and that the methods and systems may extend beyond the described embodiments.

The drawings are not necessarily to scale. Instead, certain features may be shown exaggerated in scale or in a somewhat simplified or schematic manner, wherein certain conventional elements may have been left out in the interest of exemplifying the principles of the invention rather than cluttering the drawings with details that do not contribute to the understanding of these principles.

It should also be noted that, unless otherwise stated, different features or elements may be combined with each other whether or not they have been described together as part of the same embodiment below. The combination of features or elements in the exemplary embodiments are done in order to facilitate understanding of the invention rather than limit its scope to a limited set of embodiments, and to the extent that alternative elements with substantially the same functionality are shown in respective embodiments, they are intended to be interchangeable, but for the sake of brevity, no attempt has been made to disclose a complete description of all possible permutations of features.

Furthermore, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention.

References to “one embodiment,” “at least one embodiment,” “an embodiment,” “one example,” “an example”, “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Earth observation satellites are satellites used for Earth observation from orbit. Non-military uses of Earth observation satellites include environmental monitoring, meteorology, cartography, and more. Existing systems include the Landsat program, which is a joint NASA and United States Geological Survey (USGS) program, the Moderate Resolution Imaging Spectroradiometer (MODIS) sensor launched into orbit by NASA, Sentinel-1 and Sentinel-2 which are part of the European Space Agency's Copernicus Programme, WorldView-1 and WorldView-2 owned by DigitalGlobe, as well as systems and services provided by Maxar Technologies and Planet Labs.

As described above, images provided by services such as these are not of sufficiently high quality to be used in precision farming. In particular, the images do not make it possible to detect with the necessary precision, boundaries between agricultural fields or boundaries between agricultural fields and other types of terrain.

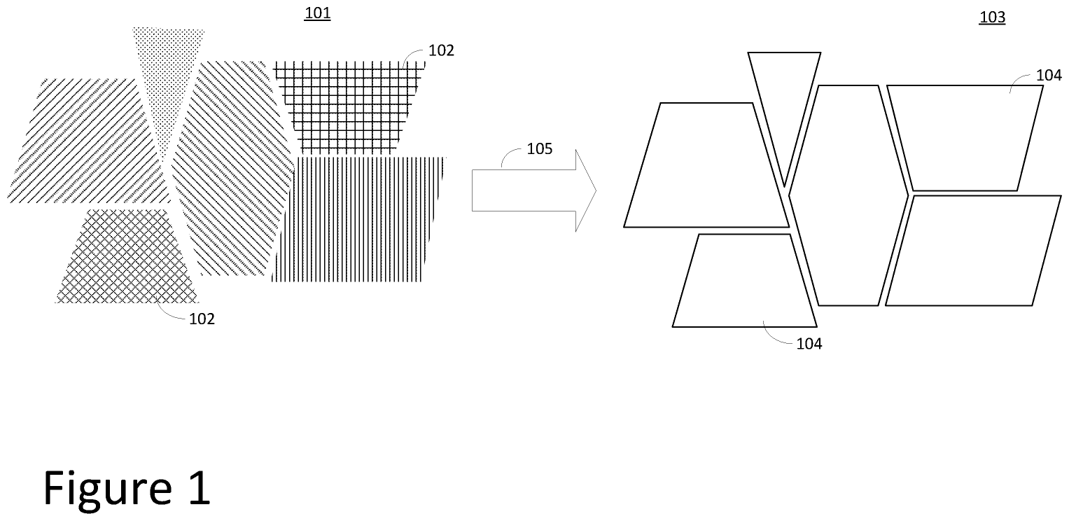

This means that there is a need for better earth observation images. As illustrated in FIG. 1 it is necessary to go from images where agricultural fields are represented as fuzzy areas providing only approximate information to images where agricultural fields are clearly and correctly delineated. (The representation in FIG. 1 is, of course, an abstraction, and not an actual satellite image.)

In the representation in FIG. 1 a satellite image, which may be one of a sequence of such images 101, shows a number of fields 102 (only some of which are provided with reference numerals). These fields 102 may include agricultural fields as well as forested or developed areas, and they are illustrated with different patterns intended to represent the different colors and textures that may be present in a satellite image. However, there are no clear boundaries between individual fields. By processing multiple such images in accordance with a process 105 according to the present invention an image 103 is produced where the fields 104 are represented with clearly delineated field boundaries.

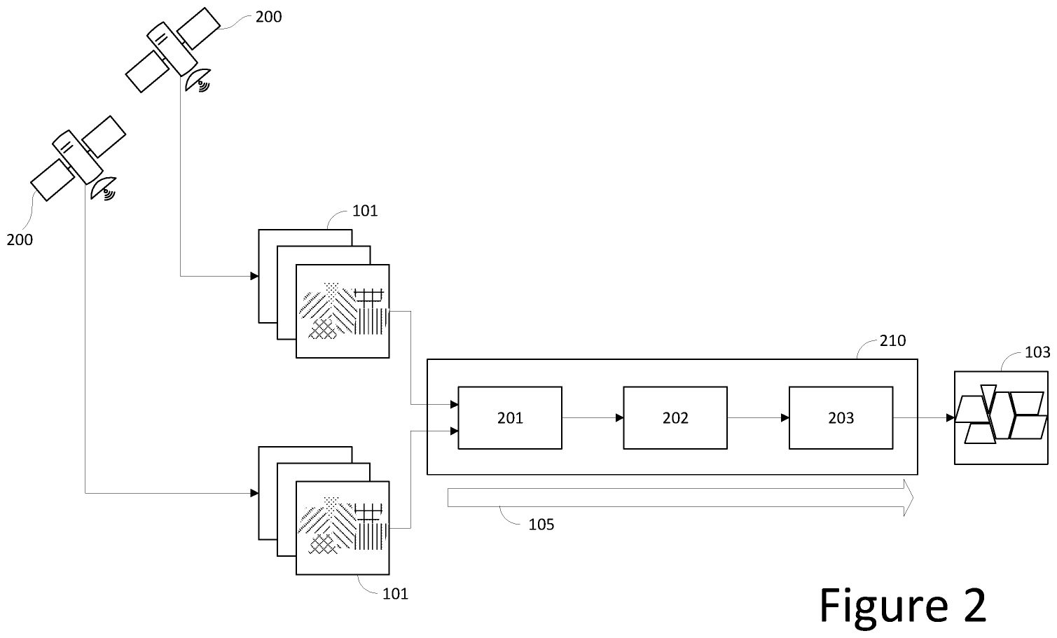

FIG. 2 shows the process 105 in further detail. One or multiple multitemporal multispectral satellite imaging data sequences are provided by one or several satellites or systems of satellites 200, such as the ones already presented above. In this context, multiple sequences means that they are obtained from multiple satellite systems, multitemporal images or image sequences are images or image sequences obtained at different stages of crop cultivation conditions across the seasons of the year, and multispectral data refers to images corresponding to different ranges of the electromagnetic spectrum, such that the small differences in the condition of the and vegetation can be distinguished. By being obtained at different points in time and/or over prolonged sequences in time, the multitemporal images represent different stages of crop cultivation conditions across the seasons of the year. The images may be multispectral such that they represent images corresponding to different ranges of the electromagnetic spectrum, such that the small differences in the condition of the vegetation can be distinguished. The imaging data sequences 101 are provided as input to a computer system 210 configured to perform a process 105 according to the present invention. The system 210 provides an output image 103 with delineated field boundaries as described above with reference to FIG. 1. It should be noted that while not currently practicable due to limitations in available satellite data, multitemporal could also refer to sequences that are closer in time. For example, some flowers open and close during the day, turn or tilt during the day, or simply change color during the day. Also, different soils, rock and pavement change temperature, and thus IR radiation, differently during the day. If appropriate satellite data were available, the present invention could be adapted to exploit this, and the term multitemporal should be interpreted accordingly.

The process 105 may be described as comprising three main steps or sub-processes, and correspondingly a system 210 according to the invention may include three subsystems. A first subsystem 201 may be configured to perform radiometric calibration, assimilation, geo-referencing, and fusion of the one or multiple multitemporal multispectral satellite imaging data sequences 101 from the one or multiple Earth Observation satellite systems 200. In embodiments receiving input data 101 from only a single input satellite system 200, the subsystem 201 may be configured to calculate the Bottom-of-Atmosphere reflectance in each pixel of the obtained image. In embodiments receiving input data 101 from multiple satellite systems 200, subsystem 201 may also be configured to translate the resultant reflectance values to the spectral bands of the constituent satellite system that is chosen as reference.

A second subsystem 202 may be configured to increase the spatial resolution of the assimilated multitemporal multispectral satellite imaging data sequence generated by the first subsystem 201. This process is not simply one of upsampling or interpolation of existing pixel information, which is performed in the first preprocessing step 201, but a process of obtaining super-resolution based on the fact that additional information is actually present in the multispectral, multitemporal sequence of input images.

Finally, a third subsystem 203 is configured to perform delineation of field boundaries based on the high-resolution multitemporal multispectral satellite imaging data sequence generated by the second subsystem 202. The third subsystem 203 may deliver as output a data file 103 containing geographical coordinates, structure, and shape of the field boundaries.

The computer system 210 may comprise one or more computers each of which may include one or more processors that are capable of executing instructions that enable the system as a whole to perform the process 105. The computer system may additionally include specific hardware to handle communication between devices, temporary and permanent storage of data, receipt of user input, display devices for presentation of text and images, and so on. The processors or other electronic circuitry in the computer system 210 may include one or more of general-purpose computers, as well as firmware and hardware specifically designed for operating in accordance with the invention, such as field programmable gate arrays (FPGA) and application specific integrated circuits (ASIC). To the extent the system 210 comprises several computers or other electronic devices, these do not have to be provided at the same location. As such, certain features of the invention may also be implemented as cloud or edge computing services. The instructions necessary to allow the processor or processors to execute methods and process steps of the invention may be stored on a non-transitory computer-readable medium.

In the present disclosure the word pixel will be used to refer to specific instances of pixels in individual images. In other words, a pixel is a combination of values representing, for example, energy in various spectral bands in a specific position in a specific image. When pixels in multiple images relate to the same geographical ground position, or the same position in image frames when the image frames have the same resolution and cover the same geographic area, these pixels will be referred to as having the same pixel position.

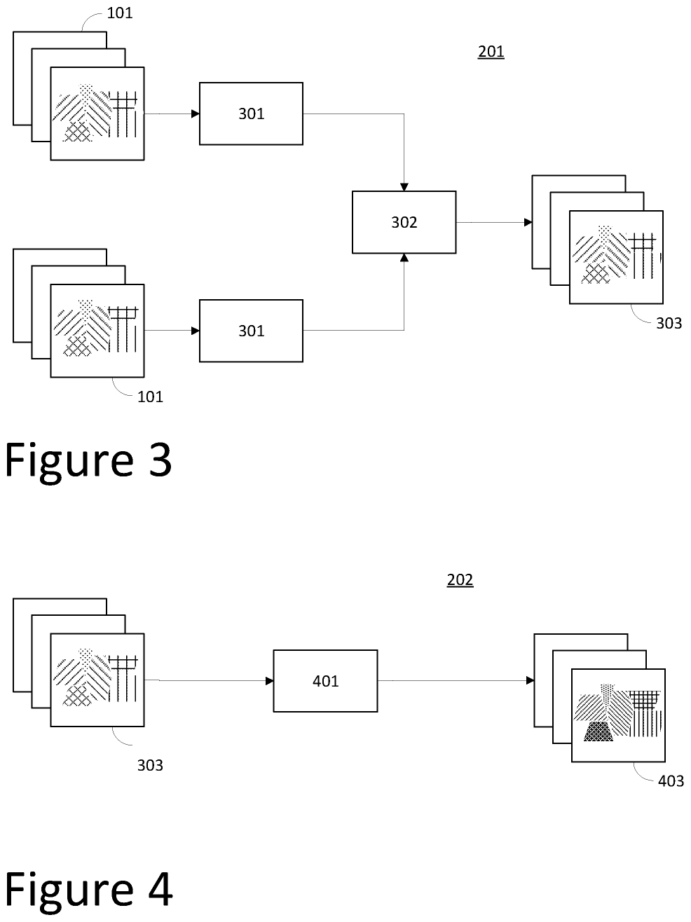

Referring now to FIG. 3, the sub-process performed by subsystem 201 will be described in further detail. The images received from the one or more satellite systems 200 may be preprocessed before they are subject to further analysis. The light that is received by the satellite sensors has passed through the earth's atmosphere once before reaching the earth's surface, and again after being reflected by the earth's surface before it can be recorded by a sensor. The amount of reflected energy recorded by a sensor must therefore be corrected in order to take atmospheric disturbances into account in order to determine the actual reflectance from the objects on the earth's surface. Several such corrections could be performed.

Initial processing may be performed separately on each stream of satellite data in a module 301. This is a computational module 301 that typically performs radiometric calibration, which is a conversion of the digital sensor output to physically interpretable values representative of the radiance actually received by the sensors, known as top of atmosphere (TOA) radiance. A portion of this radiance is energy reflected from the earth's surface, and this can be calculated using band-specific rescaling factors. The result is referred to as TOA reflectance.

However, it is conditions on the surface of the earth that are of interest, so the TOA reflectance may be further converted to bottom of atmosphere (BOA) reflectance for each pixel or groups of pixels in each image. This can be done by taking into consideration such information as atmospheric conditions when the image was obtained, solar angle, etc. This information is typically available as metadata associated with each image. The computational module 301 also typically includes data assimilation and geo-referencing functionality. In embodiments where data from more than one satellite system 200 is used, such as indicated in FIG. 3, there is one such computational module 301 for each satellite system 200. The output from the computational modules 301 may thus include images that are consistent with respect to geographical coverage, which may include correction of perspective such that the images correspond to each other regarding area covered and thus which ground features the images cover. Upsampling, interpolation or other signal processing techniques may be used to ensure that there is a correspondence between pixels in sequences of images covering the same geographical area, i.e. that the same pixel position in images in a sequence of images covering the same geographical area will correspond to the same position on the ground.

The output from the computational modules 301 is delivered to a fusion Artificial Neural Network (ANN) 302 trained to ingest a plurality of multi-temporal multi-spectral imaging datasets of different temporal and spatial resolutions, and spectral characteristics and produce a single consolidated multi-temporal multi-spectral imaging data sequence 303 as well as data fusion, which is the process of integrating multiple data sources into consistent information. The output 303 from the fusion artificial neural network 302 is thus a sequence, or sequences, of images that contain the spectral information included in the input images and that for a given sequence of images cover the same geographical area from the same perspective and with consistent georeferencing.

The conversion of input images to have the same pixel resolution with respect to the ground, as performed by the first subsystem 201 described above will, as those with skill in the art will readily understand, not increase the actual information content with respect to ground resolution in the input images. Consequently, with the resolution of image information delivered provided by most satellite systems 200 it may not be possible to achieve the required accuracy of field delineation output using methods known in the art. However, the inventors have realized that the fact that the input is multitemporal and multispectral sequences including a large number of images of the same geographical areas means that additional information actually is present in the input and can be obtained using super-resolution techniques. Several classes of super-resolution techniques, or methods, are known in the art and the invention is not limited to any specific such method. In the example described below a convolutional neural network is used to achieve super-resolution.

The process performed by the subsystem 202 is illustrated in FIG. 4. As mentioned above, this subsystem is configured to increase the spatial resolution of the assimilated multitemporal multispectral satellite imaging data sequence generated by the first subsystem 201. Thus, the input to subsystem 202 is the output 303 from subsystem 201. This data sequence is provided as input to a resolution enhancing artificial neural network 401 trained to increase the spatial resolution of an image by means of regeneration of high-resolution information from multitemporal multispectral satellite imaging data. In some embodiments a very deep residual convolutional neural network architecture is utilized as part of subsystem 202. Training of super-resolution models are well known in the art, and may, for example, be performed using Generative Adversarial Networks (GANs).

The use of super-resolution techniques on data fused image sequences as described above makes it possible to use relatively lower quality images from satellite systems that are more readily available and at a lower cost than what would have been otherwise necessary. The output from the resolution enhancing artificial neural network 401 is a high resolution, multitemporal multispectral satellite imaging data sequence 403. This is represented in the drawing by the change in the shading used to represent the terrain.

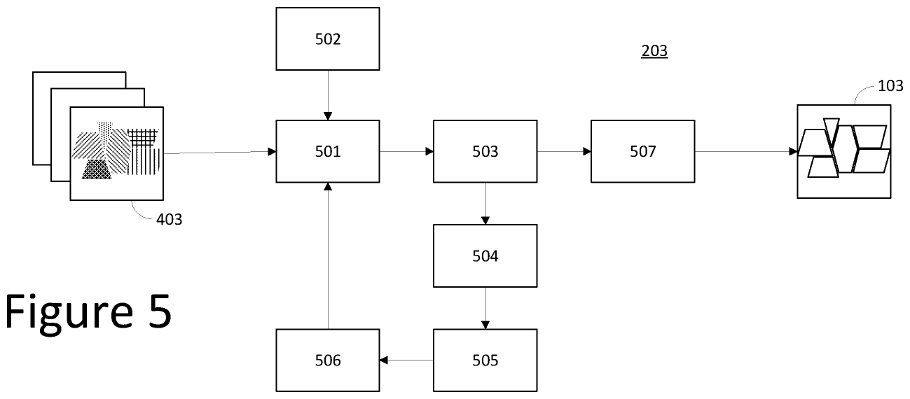

FIG. 5 is a representation of the steps performed by the final subsystem 203. Again, it is the output 403 from the previous subprocess that is received as input. This input is provided to an artificial neural network 501 trained to detect individual fields of agricultural production on the Earth's surface and delineate precise field boundaries or contribute to such detection and delineation. In some embodiments of the invention the delineating ANN 501 is simply trained to take a sequence of images of the same geographical area as input and generate a probability score for each pixel position in the data fused super-resolution image sequences. It should be emphasized that these probability scores are not calculated for pixels in images of the original image set that is delivered as input from the satellite systems 200, but for pixel positions in the image sequences resulting from the pre-processing described above. This probability score is representative of the likelihood that a pixel position corresponds to a position on the ground that is part of an agricultural field. Based on a threshold value for the probability score, a field extent segmentation mask may be generated where each pixel position is considered to be either part of an agricultural field or not. However, there may be situations where agricultural fields are close to each other, not separated by structures such as roads, vegetation such as hedges or a line of trees, and used for the same type of crop. In such situations it may be difficult to identify the boundary between the two fields. In embodiments of the invention this is addressed by training the delineating ANN 501 to generate a second output mask which explicitly identifies field boundaries. In such embodiments the delineating ANN 501 may be a deep convolutional network based on encoder-decoder architecture with multiple outputs, including a field extent segmentation mask and a field boundary segmentation mask. Additional outputs derived from the extent mask, the boundary mask, from the input images, or from combinations or post-processing of these may also be generated, for example in order to represent or enable quality assessment for the generated output masks. The neural network may be initiated (pre-trained) with manually annotated high resolution multitemporal multispectral satellite images from different parts of the world. This means that the system starts fully trained, but only based on a generic database of images, not on images specifically obtained or selected for a specific task. The pre-trained state may be referred to as a global model 502.

The delineating ANN 501 is trained through a number of epochs resulting in an updated model at the end of each epoch. The ANN 501 may be trained until validation accuracy does not improve for a number of consecutive epochs, and the resulting model after training is completed is retained. According to some embodiments of the invention several of these models from close to the end of the training are retained.

For example, if the ANN 501 is trained until validation accuracy is not increased for four consecutive epochs, training concludes. This may, for example, happen after 50 epochs. Three models may then be retained, for example the models that resulted after epochs number 42, 43, and 46. These three models may then be retained. In these embodiments, the global model 502 thus comprises the weights for all these three models resulting from training with a generic set of images. The use of more than one ANN model will be described further below.

Validation accuracy can be measured by using for example 90% of the training data to train the model and the remaining 10% of the training data to generate predictions by the trained model and comparing the output with the manually created annotation for these images. Measurement of accuracy can be done by calculating Intersection-over-Union (IoU).

The output from a model or models generated through training of the delineating neural network 501 comprises, in some embodiments, two values for each pixel position in an image sequence. One value is representative of the likelihood that the pixel position relates to a ground position which is part of a field, and the second value is representative of the likelihood that the pixel position relates to a field boundary. These values are produced by each model, so in embodiments where three models are retained from training each pixel will be associated with three pairs of values. The values may represent probabilities, but they may also simply represent respective scores that cannot be directly interpreted as probabilities. Some embodiments may only implement generation of one value per pixel position, representing field or not-field, but no value representing field boundary likelihood.

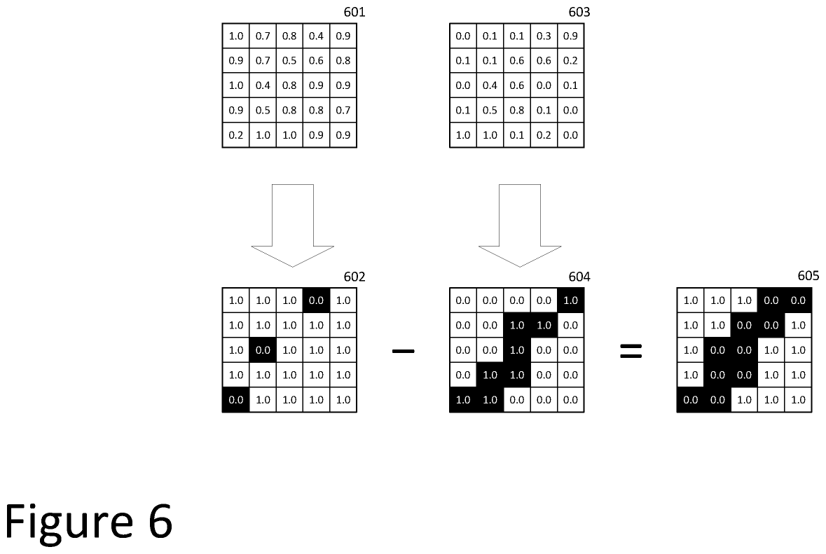

FIG. 6 shows an example of how probability scores can be used to first generate a field extent mask and a field boundary mask, and then combine these to generate a complete mask. Each block in FIG. 6 represents a segment of 5×5 pixel positions from a sequence of images 403 wherein each pixel position relates to a specific geographical ground position.

The values produced by the delineating ANN 501 models may be averaged and standard deviation may also be calculated. All values that represent the likelihood that pixel positions relate to geographical ground positions that are part of an agricultural field are used to create a first mask where each pixel position is either classified as belonging to a field or belonging to the background. In embodiments with only one ANN model a single threshold may be applied such that all probability scores above the threshold means that the pixel position will be classified as field, and all the remaining pixel positions will be classified as background. In FIG. 6 the first segment of pixel positions 601 represents the output from a single ANN model for field extent segmentation, or a corresponding average for output from multiple ANN models. These values are subject to a threshold such that each pixel position is considered to be either field or background, producing a field extent mask 602. In the example in the drawing the threshold is 0.5, but other threshold values may be chosen in embodiments of the invention. The actual probability score (i.e., how much above or below the threshold each probability is) may be used for quality assessment. In embodiments with several ANN models where the probability scores for a given pixel position is the averaged over the multiple model outputs, the standard deviation may also be calculated. In these embodiments, the average probability score is used to generate the field mask. The standard deviation may be used for quality assessment, as may the average probability score before application of the threshold.

Similarly, all values representing field boundaries, delivered as output from a single ANN model or averaged over several ANN model outputs, are used to create a second grid of probabilities. A segment of such a grid is shown as a segment 603 in FIG. 6. The field boundary mask will be based on these probability scores by application of a threshold in a method corresponding to the one just described for the field extent mask. In the example in FIG. 6, again with the threshold set to 0.5, a field boundary mask is represented by a segment 604. These masks can be combined by subtracting the field boundary mask from the field extent mask. This has the advantage that while the field extent mask may tend to combine two adjacent fields into one with only a few background pixel positions that will not be interpreted as a boundary, the combination of the two masks produces a clear field boundary two pixel positions wide. Embodiments that only develop a field extent mask and no field boundary mask will only include the probability scores in segment 601 and segment 602 will represent the final output mask.

The output from the delineating neural network 501 may thus include a combined mask 605 where pixel positions are either identified as belonging to a field, or not. Pixel positions that do not belong to a field but comprise narrow bands of background pixel positions between adjacent fields may be interpreted as field boundaries. Other background pixel positions may simply by anything that is not a field, including woodland, streets or roads, buildings, etc. The output from the delineating ANN 501 may also include a representation of a confidence level for the generated output. This confidence level may be based on standard deviations calculated from the output values provided by the delineating neural network 501. Several ways of calculating the confidence level may be contemplated. For example, in embodiments with multiple models, if the multiple models produce very similar results, the standard deviation between probability values for corresponding pixel positions from the respective models will be low. Similarly, the standard deviation between probability values for pixel positions determined to belong to a particular field may be calculated and used as a measure of confidence in that the field actually has the determined extent. It is also possible to consider the extent to which probability values are close to either 0.0 or 1.0. If many values are close to 0.5, or some other threshold value, it can be assumed that this indicates uncertainty.

The output from the delineating ANN 501 may be delivered as input to a quality assessment module 503 which calculates the confidence levels described above. Alternatively, the confidence levels are calculated by the delineating ANN 501 module and received by the quality assessment module 503 as input. It will be understood from the discussion above that there may be confidence levels for individual pixel positions (e.g., based on standard deviation between output from multiple models, or simply the closeness to either 0.0 or 1.0 for the provided output probability), as well as aggregate confidence levels for individual fields or for an entire picture or area. Thus, a number of different metrics may be constructed to represent confidence level and determine an overall quality of the output. Consequently, different types and levels of threshold may be used to determine whether the output from the delineating ANN 501 is of an acceptable quality.

If according to such a predefined metric, the confidence level is above a pre-defined threshold, the output from the delineating ANN 501 may be forwarded to a post-processing module 507. For example, a confidence threshold may be defined such that confidence for a given pixel position increases when the standard deviation between probability scores for that pixel position decreases. The quality assessment module 503 may require that the average or median confidence level for all pixel positions in an image or for each field and/or field boundary in the picture, is above a certain value. The confidence levels for fields and boundaries may, for example, be normalized probability scores of the model's final output or standard deviation of normalized probabilities of the model's output masks calculated at different epochs of training, as described above. The quality assessment module 503 may, for example, require that the confidence level of a certain percentage of all pixel positions or fields (for example for 90 or 95% of all pixel positions or fields) is above a threshold. If this requirement is not satisfied, the system may not forward the results to the post-processing module 507, but instead reject the results and issue an alert that indicates the need for retraining of the model or models. This alert may be accompanied by an identification of areas with a low confidence level. The images containing these areas may be selected for manual delineation (annotation), which may be performed on a workstation 504 by an operator. The manually annotated images resulting from this process may be delivered as input to a retraining module 505 configured to perform retraining of the delineating neural network 501 with a dataset which now includes the images originally used to create the global model 502 as well as the manually annotated local images. The result will be a local model 506 which should improve the output from the delineating neural network 501. The training performed by the training module 505 may correspond to the method used to train the global model 502 in terms of performing a number of epochs until some criteria is reached and keeping the same number of models from this training as during training of the global model 502. However, adjustments may be made to the training process in order to adapt training to better capture specific requirements associated with the particular area covered by the images.

As mentioned above, various metrics and associated thresholds may be used to determine quality assessment. The specific metrics chosen in a particular embodiment and the thresholds chosen in order to differentiate between results that should be accepted and results that should be rejected by the quality assessment module 503 may be determined by visually inspecting the outputs of the model and also by using manually delineated test data to calculate Intersection-Over-Union (IoU) accuracy metrics for different thresholds in accordance with requirements for specific embodiments. In other words, if it is found that the quality assessment module 503 accepts results that upon inspection, or through measurement of IoU against manually delineated test data, are not sufficiently accurate, the threshold may be raised. Similarly, if it is found that acceptable results are rejected by the quality assessment module 503 the threshold may be lowered.

The need for training on local images may be a result of two factors. First, the global model may be based on too many images with features that are irrelevant to the local task, for example effects of snow and ice resulting in different reflection from the ground in an area that is always above freezing, certain types of vegetation with colors or color changes that do not occur in the area, certain conditions of the soil resulting in different heating and cooling cycles, etc. In addition, the local conditions may include similar features that are highly common locally but relatively unusual in the global training set.

The post processing module 507 may vectorize, smooth and denoise the results provided from the delineating neural network 501 and generate computer files that describe the precise geographical location, structure, and shape of agricultural fields. These files 103 may be delivered as output in raster and/or vector format.

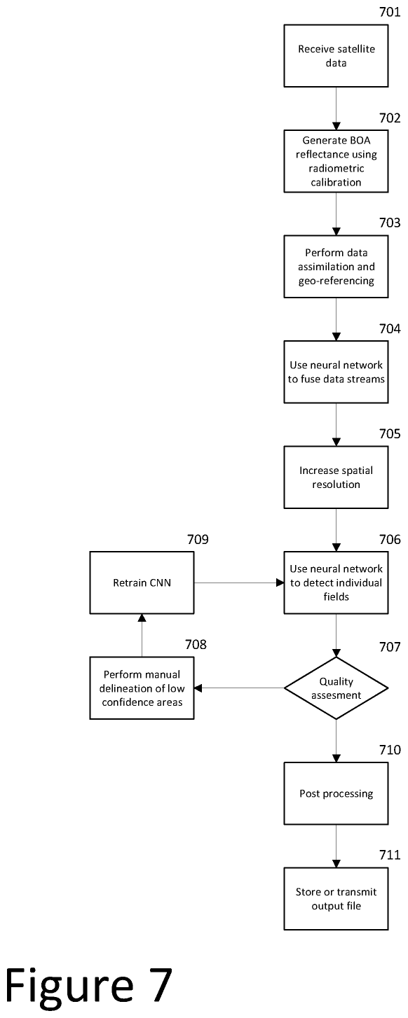

The method performed by the system described above will now be summarized with reference to FIG. 7. The method commences when satellite input data in the form of data from one or more satellite systems in step 701. The data is multitemporal in the sense that images are obtained at several points in time that are sufficiently removed from each other to represent different stages of crop cultivation. Other conditions that vary over time may also be exploited, such as variability in reflectance during the day caused by wetness of the soil, vegetation reacting to sunlight, as well as variability in temperature absorption, and thus in infrared emission, during the day caused by differences in soil, foliage, other vegetation, pavement, buildings and more.

In order to observe as many of these changes as possible the input is preferably multispectral such that information relating to the visible spectrum as well as infrared is included. Different bandwidths will carry different information with respect to the condition of the observed ground.

In step 702 bottom of atmosphere (BOA) reflectance is generated from the received sensor input using radiometric calibration. This may be performed for every pixel or every group of pixels and may differ from one image to the next based on atmospheric conditions, spectral information, solar angle, and other factors.

The input data may also be assimilated and geo-referenced, as shown in step 703. Data assimilation takes data from different sources, or of different types, and combines them in order to estimate the state of a system based on a model of that system. Geo-referencing is simply the association of images with geographic coordinates.

In a next step 704 the assimilated and geo-referenced images are fused into a single data stream. This step may be performed by an artificial neural network as described above.

The consolidated multi-temporal multi-spectral imaging data sequence created by the data fusion step 704 is then subjected to a process to increase spatial resolution in step 705. This process may be performed by a second artificial neural network. The resulting output should now have sufficient resolution and image quality for field detection, which is performed by a delineating artificial neural network in step 706. The neural network may initially be trained on a global model, as described above.

In a following step 707 the quality of the output from the field delineation process in step 706 is assessed based on confidence levels which are produced as part of the delineation process. If it is determined that the quality is not sufficiently high according to some predetermined criteria, the process may move to step 708 where manual delineation of low confidence areas may be performed. From a system point of view this means that selected images from the data stream with added annotations are delivered as input to a further training process for the convolutional neural network in step 709.

The retraining will provide the CNN with a local model which is used for further delineation in a return to step 706.

If, or when, quality assessment in step 707 indicates that quality is sufficient according to the predefined criteria, the process may move on to step 710 where post processing is performed. Post processing may include vectorization, smoothing and denoising of the results provided from the CNN. Subsequently, in step 711, the resulting data may be provided as output in the form of files or streams that may be stored or transmitted.

The embodiments described above make reference to a fusion artificial neural network 302, a resolution enhancing artificial neural network 401, and a delineating artificial neural network 501. The descriptive terms fusion, resolution enhancing, and delineating are first and foremost intended to name these neural networks so they can be readily differentiated from each other. Functionally the terms are only intended to indicate the processes the neural networks are part of and contribute to. They do not imply that the neural networks alone perform the respective functions, which may rely on additional modules, components, or features. In some embodiments the features may mainly, or solely, be performed by some other method than one based on use of a neural network, as follows from the appended claims.

To the extent that this disclosure describes features and combination of features that are not covered by the appended claims, the applicant reserves the right to seek protection for such features and combinations in a divisional application. In particular, the generation of two output masks, one trained to differentiate field from non-field pixel positions and one trained to differentiate field boundary from non-field boundary pixel positions, may be used in embodiments that do not include super-resolution techniques provided that the source images provided by satellite systems have a sufficiently high resolution for the demands of a particular application. In general, various features and steps described herein may be configured differently, for example in a different order in the processing flow, so long as results that are required as input to one function have been generated upstream of that function. Features and steps that are disclosed with reference to specific examples are not limited to embodiments including all the features of that example, since no attempt has been made to describe all possible combinations of subsets of the features described.

1. A method in a computer system for delineating agricultural fields using satellite images, comprising:
obtaining at least one multitemporal, multispectral satellite image sequence (101);
pre-processing (702, 703) the images in the at least one multitemporal, multispectral satellite image sequence (101) to generate a pre-processed image sequence (303) of multitemporal multispectral images covering a specific geographical region;
using a super-resolution method (705) on the images in the pre-processed image sequence to generate a high-resolution image sequence (403) of multitemporal multispectral images where corresponding pixel positions in images in the sequence relate to the same geographical ground position; and
using a delineating artificial neural network (501) to classify (706) pixel positions in the high-resolution image sequence (403) as being associated with a geographical ground position that is part of an agricultural field (104) or not being part of an agricultural field.

2. A method according to claim 1, wherein the super-resolution method (705) is performed by a resolution enhancing convolutional neural network (401).

3. A method according to claim 1, wherein the pre-processing (702, 703) includes at least one of, for pixels in the images in the at least one obtained satellite image sequence (101): converting (702) received pixel values to bottom of atmosphere (BOA) reflectance, performing data assimilation, and performing geo-referencing (703).

4. A method according to claim 1, wherein the at least one multitemporal, multispectral satellite image sequence (101) is a plurality of such image sequences, the method further comprising using a fusion artificial neural network (302) to receive the plurality of multitemporal, multispectral imaging sequences (101) as input and produce a single consolidated multi-temporal multi-spectral imaging data sequence (301) as output.

5. A method according to claim 1, wherein the delineating artificial neural network (501) is trained to generate two output masks, wherein a first output mask (602) classifies pixel positions as field or background, a second output mask (604) classifies pixel positions as field boundary or not field boundary, and a combined output mask (605) where pixel positions classified as field in the first output mask (602) are re-classified as background if they are classified as field boundary in the second output mask (604).

6. A method according to claim 1, wherein the delineating artificial neural network (501) generates probability scores for the pixel positions in the high-resolution
image sequence (403) and classification of pixel positions is performed based on whether respective probability scores are above or below a predetermined threshold value.

7. A method according to claim 6, wherein multiple models from the training of the delineating artificial neural network (501) have been retained and the classification of pixel positions in the high-resolution image sequence (403) includes using the multiple models to, for the respective pixel positions:
produce multiple probability scores, and
calculate an average probability score.

8. A method according to claim 7, further comprising, for the respective pixel positions:
calculating a standard deviation from the multiple probability scores.

9. A method according to claim 1, further comprising:
performing a quality assessment (707) of the classification of pixel positions by the delineating artificial neural network (501), and, if the quality assessment produces a result that fails to satisfy a predetermined quality requirement,
manually annotating agricultural fields in images of one or more high-resolution image sequences (403) that cover areas for which quality assessment has failed, and
retraining the delineating artificial neural network (501) with the manually annotated high-resolution image sequences (403).

10. A method according to claim 1, further comprising:
combining the classification of pixel positions from the delineating artificial neural network (501) with an image representing a corresponding geographical area; and
storing or transmitting the result as an image where agricultural fields are delineated.

11. A computer-based system for delineating agricultural fields based on satellite images, comprising:
a first subsystem (201) configured to receive at least one multitemporal, multispectral satellite image sequence (101) and pre-process (702, 703) the images in the at least one multitemporal, multispectral satellite image sequence to generate a pre-processed image sequence (303) of multitemporal multispectral images covering a specific geographical region;
a second subsystem (202) configured to perform a super-resolution method (705) on the images in the pre-processed image sequence to generate a high-resolution image sequence (403) of multitemporal multispectral images where corresponding pixel positions in images in the sequence relate to the same geographical ground position; and
a third subsystem (203) including a delineating artificial neural network (501) trained to classify (706) pixel positions in the high-resolution image sequence (403) as being associated with a geographical ground position that is part of an agricultural field (104) or not being part of an agricultural field.

12. A computer-based system according to claim 11, wherein the second subsystem (202) includes a resolution enhancing convolutional neural network (401) trained to receive multitemporal, multispectral image sequences as input and generate high-resolution image sequences as output.

13. A computer-based system according to claim 11, wherein the first subsystem (201) includes at least one of: a module configured to convert received pixel values to bottom of atmosphere (BOA) reflectance values, a data assimilation module, and a geo-referencing module.

14. A computer-based system according claim 11, wherein the first subsystem (201) is configured to receive a plurality of multitemporal, multispectral satellite image sequences (101) and includes a fusion artificial neural network (302) to receive the plurality of multitemporal, multispectral imaging sequences (101) as input and produce a single consolidated multi-temporal multi-spectral imaging data sequence (301) as output.

15. A computer-based system according to claim 11, wherein the delineating artificial neural network (501) is trained to generate two output masks, a first output mask (602) that classifies pixel positions as field or background, a second output mask (604) that classifies pixel positions as field boundary or not field boundary, and a combined output mask (605) where pixel positions classified as field in the first output mask (602) are re-classified as background if they are classified as field boundary in the second output mask (604).

16. A computer-based system according to claim 11, the delineating artificial neural network (501) is trained to generate probability scores for the pixel positions in high-resolution image sequences (403) and to classify pixel positions based on whether respective probability scores are above or below a predetermined threshold value.

17. A computer-based system according to claim 16, wherein multiple models from the training of the delineating artificial neural network (501) have been retained and the classification of pixel positions in the high-resolution image sequence (403) includes using the multiple models to, for the respective pixel positions:
produce multiple probability scores, and
calculate an average probability score.

18. A computer-based system according to claim 17, wherein the delineating artificial neural network (501) is further configured to, for the respective pixel positions:
calculating a standard deviation from the multiple probability scores.

19. A computer-based system according claim 11, further comprising: in the third subsystem (203), a quality assessment module (503) which is configured
to perform a quality assessment of the classification of pixel positions by the delineating artificial neural network (501), and, if the quality assessment produces a result that fails to satisfy a predetermined quality requirement, issue an alert indicative of a need to retrain the delineating artificial neural network (501);
a workstation (504) including a display and a user interface, and configured to display high-resolution images of geographical areas and receive user input to generate annotation of agricultural fields present in the high-resolution images; and
a retraining module (505) configured to perform retraining of the delineating artificial neural network (501) using manually annotated high-resolution image sequences (403) provided by the workstation (504).

20. A computer-based system according to claim 11, further comprising a post-processing module configured to combine the classification of pixel positions from the delineating artificial neural network (501) with an image representing a corresponding geographical area; and storing or transmitting the result as an image where agricultural fields are delineated.

21. A non-transitory computer-readable medium storing instructions enabling one or more processors to perform one of the methods of claim 1.
